(19) United States
(12) Patent Application Publication
(10) Pub. No.: US 2008/0082973 A1
(43) Pub. Date: Apr. 3, 2008

(54) Method and Apparatus for Determining Software Interoperability

(76) Inventors: Brenda Lynne Belkin, Wayne, PA (US); Tanjore K. Srinivas, Howell, NJ (US)

Correspondence Address: RYAN, MASON & LEWIS, LLP, 90 FOREST AVENUE, LOCUST VALLEY, NY, 11560, US

(21) Appl. No.: 11/536,838

(22) Filed: Sep. 29, 2006

(51) Int. Cl. G06F 9/45

(52) U.S. Cl. 717/155

(57) ABSTRACT

Software interoperability is determined in a system comprising components capable of operating using different combinations of software applications. Training data is received for the system indicating changes to a system metric as a function of the different combinations of software applications. From the training data, it is determined which of the components directly or through interactions with other components have a statistically significant effect on the system metric when changing between the different combinations of software applications. From the training data, a software interoperability decision tree for the system is formulated. The software interoperability decision tree uses those components determined to have a statistically significant effect on the system metric as decision tree attributes.

### FIELD OF THE INVENTION

The present invention relates generally to systems running multiple software applications, and, more particularly, to techniques for determining software interoperability in systems running multiple software applications.

### BACKGROUND OF THE INVENTION

Modem enterprise systems typically comprise multiple systems that are networked together to implement an enterprise's particular application. An enterprise system may, for example, comprise converged voice and data networks including many hundreds of multi-vendor system components and third-party applications. Generally, most of these system components execute software applications in order to perform their respective functions. It is, therefore, critical to the successful delivery of reliable and highly available voice and data services in such a system environment that the software applications running on the multitude of system components be compatible with one another.

Software incompatibilities in a system running multiple software applications (hereinafter a “multi-application system”) such as a typical enterprise system may cause, for example, one system component to interfere with other system components. Severe interference or lack of interoperability can even result in system crashes or, at the least, in poor performance of one or more system components within the multi-application system. To compound the problem, the combination of software applications running within a given multi-application system is frequently changed as new system components are introduced to the system and existing software applications are upgraded to add new capabilities to existing system components or to address known system component issues. Unfortunately, each such change puts the multi-application system at risk for problems with software interoperability.

The interoperability of the software running in a multi-application system maybe represented by a software interoperability model for the multi-application system of interest. Advantageously, such a model may indicate which software applications may need to be modified to avoid software incompatibilities and to achieve the best possible system performance. In the past, where only a small number of software applications ran in a given multi-application system, such a model could be determined manually by a system administrator simply by observing the impact of different software applications and combinations of software applications on a particular multi-application system metric of interest. However, in modem multi-application systems, the sheer number of software applications in the system environment makes the manual development of a software interoperability model extremely tedious and prone to human error. In addition, testing all possible combinations of software applications within a multi-application system is frequently not practical. For any system administrator in the role of maintaining the reliability of services delivered by a multi-application system, the software update or other upgrade process is often a stressful event since there are frequently no means for risk reduction beyond reading update notices supplied by the application manufacturers. The resulting “trial and error” approach to software interoperability has been a major source of financial loss to owners of multi-application systems due to service disruptions.

As a result, there is a need for methods and apparatus for developing software interoperability models for complex multi-application systems.

### SUMMARY OF THE INVENTION

Embodiments of the present invention address the above-identified need by providing methods and apparatus for developing software interoperability models for complex multi-application systems. Advantageously, such models may allow a system administrator to determine optimized software configurations and to determine whether or not to introduce new software applications or to perform software updates of existing software applications.

In accordance with an aspect of the invention, software interoperability is determined in a system comprising components capable of operating using different combinations of software applications. Training data is received for the system indicating changes to a system metric as a function of the different combinations of software applications. From the training data, it is determined which of the components directly or through interactions with other components have a statistically significant effect on the system metric when changing between the different combinations of software applications. From the training data, a software interoperability decision tree for the system is formulated. The software interoperability decision tree uses those components determined to have a statistically significant effect on the system metric as decision tree attributes.

In accordance with an illustrative embodiment of the invention, a multi-application system comprises a multiplicity of system components capable of operating using a plurality of different combinations of software applications. A modeling system having input/output devices, a data processor and a memory is connected to this multi-application system. The modeling system first inventories all the possible combinations of software applications that may be run on the multi-application system at any given time. Next, training data is generated for the multi-application system by measuring changes to a system metric as a function of the different possible combinations of software applications. Analysis of Variance (ANOVA) techniques are then applied to the training data to determine which system components directly or through interactions with other system components have a statistically significant effect on the system metric when changing between the plurality of different combinations of software application. Finally, a decision tree inference algorithm is applied to the training data and a software interoperability decision tree is formulated for the multi-application system using those components determined to have a statistically significant effect on the system metric as decision tree attributes

These and other features and advantages of the present invention will become apparent from the following detailed description which is to be read in conjunction with the accompanying drawings.

### BRIEF DESCRIPTION OF THE DRAWINGS

FIG. 1 shows a block diagram of a multi-application system and a modeling system in which aspects of the invention may be implemented.

FIG. 2 shows an illustrative flow diagram for determining a software interoperability model for the FIG. 1 multi-application system in accordance with aspects of the invention.

FIG. 3 shows a block diagram of an exemplary call center solution on which aspects of the invention are demonstrated.

FIG. 4 shows a table of trouble restore times for the FIG. 3 call center solution.

FIG. 5 shows a table of the categories of restore times for the FIG. 3 call center solution.

FIG. 6 shows a table of ANOVA analysis results for the FIG. 3 call center solution.

FIG. 7 shows a software interoperability decision tree for the FIG. 3 call center solution.

### DETAILED DESCRIPTION OF THE INVENTION

The present invention will be described with reference to illustrative embodiments. For this reason, numerous modifications can be made to these embodiments and the results will still come within the scope of the invention. These numerous modifications will become apparent to one skilled in the art in light of the following description. No limitations with respect to the specific embodiments described herein are intended or should be inferred.

The term “software” as used herein is intended to encompass any set of instructions, programs or procedures that may be executed by components of a multi-application system. The term “software” is intended to be construed broadly and is intended to encompass software elements at all levels, including, but not limited to, operating systems, middleware systems, databases, system applications and the like, that typically operate from read/write memory, as well as software elements that are embedded in hardware devices, commonly referred to as “firmware.”

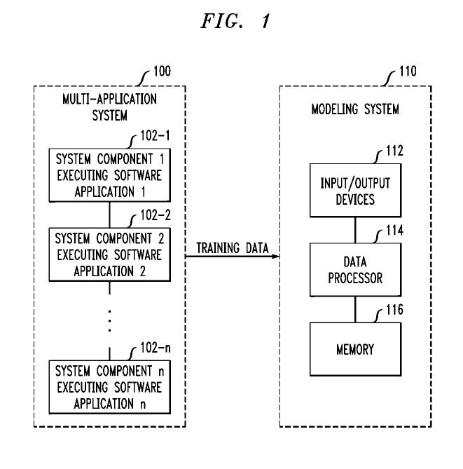

FIG. 1 shows a block diagram of an illustrative multi-application system 100 and a modeling system 110 in which aspects of the invention may be implemented. The multi-application system comprises n system components 102-i, where i=1, 2, 3 . . . n. The modeling system, in turn, comprises input/output devices 112, a data processor 114 and a memory 116.

The multi-application system 100 on which the modeling system 110 is acting may be any kind of multi-application system that includes one or more system components. The invention is therefore not limited to a particular type of multi-application system. The multi-application system may, for example, be a telecommunications network capable of transmitting voice information, digital data or some combination of both. In such a network, the system components 102-i may comprise some combination of well-known data processing and communications devices including, but not limited to, database and web servers, application servers, mainframes, personal computers, gateways, routers, bridges, switches, hubs and repeaters. Moreover, the system components may further or alternatively comprise well-known circuit-switched hardware devices like those used in Public Switched Telephone Networks (PSTNs) such as switches, digital cross-connect systems, optical networking components, loop devices, and software applications that monitor, provision, and bill for services consumed from the PSTN.

What is more, the multi-application system 100 may be, as just one additional example, any type of computing device capable of running multiple software applications such as a typical general purpose computer. One skilled in the art will recognize that a typical general purpose computer will be operative to run a multitude of software applications, including one or more operating system, various utilities and a number of task-specific applications (e.g., software applications for word-processing, spread-sheet analysis and drafting). Alternatively, the multi-application system maybe a large complex service provider environment where there are typically 30-40 support systems operating with hundreds or thousands of network elements, all potentially vulnerable to software interoperability issues.

The modeling system 110, moreover, may be any type of computing device comprising one or more input/output devices, a data processor and a memory. The modeling system may, for example, comprise a computing device within what is commonly referred to as the “IBM PC Compatible” class of personal computers. Alternatively, the modeling device may run on a mid-size computing platform or be part of a larger mainframe-type of computer. As indicated in FIG. 1, the modeling system receives training data (described in further detail below) from the multi-application system 100. The transfer of the training data from the multi-application system to the modeling system may be through a direct connection between these two elements. Alternatively, the training data may be stored on a computer-readable storage medium (e.g., magnetic disk, flash memory, compact disc (CD) or digital versatile disc (DVD)) using a disk drive device connected to the multi-application system. The data on the computer-readable storage medium may be subsequently transferred into the memory 116 of the modeling system.

In the illustrative multi-application system 100, each of the system components 102-i executes one or more respective software applications designed to perform one or more particular functions with the multi-application system. As will be anticipated, it is periodically desirable to introduce new software applications to the multi-application system and/or to update the software applications already present in the system in order to impart the system with new functionality or to address known system component issues. Nevertheless, such changes to the combination of software applications running in the multi-application system will preferably be given careful consideration. Because of the strong interaction between the system components, each of the newly introduced or modified software applications may affect the operation of other system components or the combination of software applications may affect the overall functionality or performance of the multi-system application as a whole. Software incompatibilities may cause, for example, one system component to interfere with other system components. Severe interference or lack of interoperability can even result in system crashes or, at the least, in poor performance of one or more system components within the multi-application system.

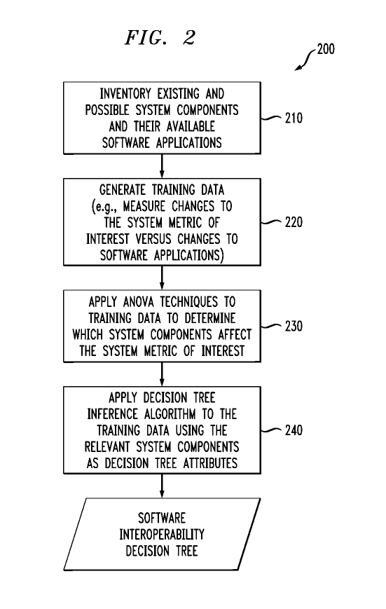

FIG. 2 shows a flow diagram of a method 200 for determining a software interoperability model for the multi-application system 100 using the modeling system 110. When carried out in accordance with aspects of this invention, the resultant software interoperability model predicts how changes to the combination of software applications running on the multi-application system will affect a given system metric. The system metric may, for example, be indicative of the multi-application system's speed, reliability, cost, power consumption, serviceability or any other quantifiable descriptive system parameter of interest.

As indicated in FIG. 2, the method 200 starts at step 210 by inventorying the system components within the multi-application system 100, the different software applications (i.e., the different software releases) that each of these system components is capable of running, and/or any new system components and their associated software applications that a system administrator may want to introduce to the multi-application system. This information is then utilized to determine the possible combinations (i.e., iterations) of software applications that may be run by the multi-application system at any one time.

Step 220, in turn, comprises generating training data for the multi-application system 100. Generating the training data comprises running the multi-application system with each of the possible combinations of software applications determined in step 210 and measuring the associated system metric of interest. Multiple tests (i.e., at least two) are preferably performed on each of the possible combinations of software applications in order to reduce the impact of faulty results (i.e., outliers). As a result of these measurements, the training data will indicate changes to the system metric of interest as a function of the different combinations of software applications running on the multi-application system. If the system metric of interest is, for example, system speed, it is likely that some combinations of software applications will result in increases in system speed while other combinations will result in reductions in system speed. Nevertheless, if there are many combinations of software applications under test, it is unlikely at this step in the method 200 that a system administrator will recognize which particular system components and system component interactions are precisely responsible for these changes.

Step 230 comprises having the modeling system 110 perform ANOVA techniques on the training data gathered in step 220 with the purpose of identifying which system components and system component interactions have a statistically significant effect on the system metric of interest when changing among the different combinations of software applications capable of being run by the multi-application system 100. In general terms, ANOVA techniques are statistical devices that facilitate the comparison of several factors' effects on a result of interest. In other words, ANOVA techniques provide a means of weighing the relative importance of parameter contributions to a result. The ANOVA techniques also estimate the random effects which are distinct from the true factor contributions.

ANOVA techniques are commonly used and, as a result, will be familiar to one skilled in the art. These techniques are described in a number of readily available references including, for example, R. G. Miller, Beyond ANOVA: Basics of Applied Statistics, CRC Press LLC, 1998, which is incorporated herein by reference. Moreover, ANOVA techniques have been implemented in commercially available software such as, for example, SAS/STAT and JMP from SAS Institute, Inc. (Cary, N.C., USA) and Mathematica from Wolfram Research, Inc. (Champaign, Ill., USA). Accordingly, such commercially available software may be used to implement this invention in the modeling system 110. Of course, non-commercial ANOVA software may also be implemented in the modeling system if a system administrator so desires. One skilled in the art will recognize how to develop and implement such non-commercial software.

The ANOVA techniques used in step 230 will preferably associate each system component and system component interaction in the multi-application system 100 with various well-known values such as, among others, “F-values” and “P-values.” One skilled in the art will recognize that F-values indicate the statistical likelihood that the associated system component or system component interaction has an effect on the system metric of interest. P-values, moreover, indicate the level of statistical certainty for the associated F-values. An F-test to determine these values makes a statistical comparison between the variances of two data sets. The greater is the difference between two statistical distributions, the higher is the confidence that the two distributions are different (and the lower is the P-value). Accordingly, those system components and system component interactions that have a statistically significant effect on the system metric of interest when changing between the different combinations of software applications can easily be determined with these values. Confidence levels of 95 percent or greater (indicated by P-values less than or equal to 0.05) are generally considered by those skilled in the art to be a “high confidence” level that two distributions under study are statistically different. As a result, P-values indicating confidence levels of 95% or greater are typically good indicators that the associated factor (in this case, a system component or a system component interaction) has a statistically significant effect on the system metric of interest and should be included in the subsequent analysis.

Next, in step 240, the modeling system 110 formulates and outputs a software interoperability decision tree for the multi-application system 100 from the training data using as decision tree attributes those system components determined, either directly or through a system component interaction, to have a statistically significant effect on the system metric of interest in step 230. Like the ANOVA techniques, decision tree techniques will be well-known to one skilled in the art and are described in a number of readily available references, including L. Breiman, Classification and Regression Trees, CRC Press LLC, 1994, which is also incorporated herein by reference. Generally, a decision tree is a graphical representation of decisions and their possible consequences in the form of a tree with nodes, branches and endnodes (i.e., leaves in the tree). The nodes are the decision tree attributes. The branches emanating from the nodes are associated with possible values for the attributes. The endnodes at the end of some of the branches are the conclusions for a given path through the tree. Advantageously, decision trees are typically simple to understand and interpret.

With the decision tree attributes determined in step 230, a decision tree for the multi-application system 100 may be formulated by, for example, applying a decision tree inference algorithm to the training data. There are several such decision tree inference algorithms. The Iterative Dichotomiser 3 (ID3) algorithm, for example, is a well-known decision tree inference algorithm for generating decision trees from experimental data. Other well-known decision tree inference algorithms are C4.0, C4.5 and C5. The ID3, C4.0, C4.5 and C5 algorithms are described in greater detail in, for example, X. Wu, Knowledge Acquisition from Databases, Intellect Books, 1995, which is incorporated herein by reference. Moreover, these algorithms are available in many commercially available software applications, such as ExpertEase from ExpertEase Software (New York, N.Y., USA). Accordingly, such commercially available software may be used to implement this invention in the modeling system 110. Non-commercial software may also be implemented in the modeling system if a system administrator so desires. As before, one skilled in the art will recognize how to develop and implement such non-commercial software.

Thus, the ANOVA techniques applied in step 230 of FIG. 2 allow the decision tree inference algorithm applied in step 240 to be focused on only those system components that, directly or through interactions with other system components, have a statistically significant effect on the system metric of interest. Advantageously, the decision tree resulting from step 240 predicts the effects of different software combinations on the system metric of interest. Such a model may allow a system administrator to readily determine optimized software configurations and to determine whether or not to introduce new software applications or to perform software updates of existing software applications.

It should be noted that, while step 220 in FIG. 2 describes an explicit step for generating the training data, training data may be generated by observing how well different combinations of software applications work together when run by one or more existing multi-application systems in the field (i.e., the training data may be based on experiential data rather than experimental data). As a result, it is contemplated that training data may be produced through the regular course of business rather than through experimentation solely directed at producing a software interoperability model in accordance with aspects of this invention. Of course, it is likely that training data derived through the regular course of business may not sample each and every possible combination of software applications that can be run by the multi-application system under test since the real world provisioning of operating, mission-critical multi-application system may not facilitate such extensive experimentation. Nevertheless, the method 200 described above can accommodate such gaps to some extent, although the certainty in the resultant software interoperability model maybe adversely affected.

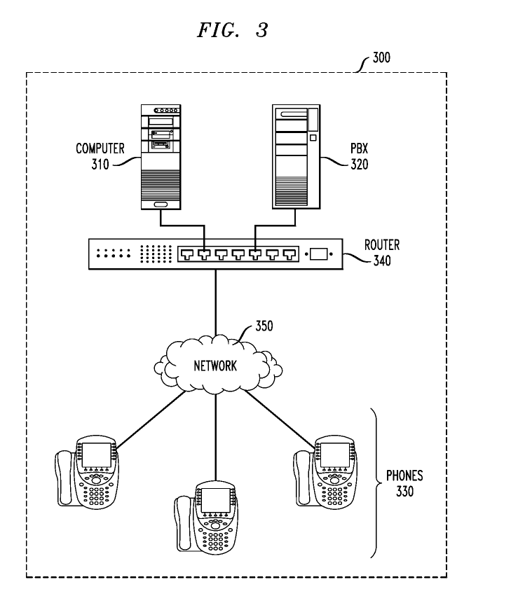

For the purpose of further describing the invention, the application of the method 200 shown in FIG. 2 to an exemplary multi-application system will now be described in conjunction with FIGS. 3-7. FIG. 3 shows the exemplary multi-application system, namely, a call center solution 300. The call center solution comprises a computer component 310, a public branch exchange (PBX) component 320, and phone components 330. As is typical in real-world call center solutions, the computer component and PBX component are connected to the phone components through a router component 340 and a network 350 (e.g., local area network or wide area network). In this example, the system metric that is of interest with respect to the call center solution is assumed to be the amount of time (in 15 minute intervals) that it takes a service technician or system tester to diagnose and remedy operational problems occurring within the call center solution (“trouble restore time”).

Applying step 210 of FIG. 2 to the exemplary call center solution 300 comprise inventorying all the possible combinations of software applications that may be run on the call center solution. For purposes of the example, it is determined that the computer component 310 is capable of running two different releases of a certain application, namely R7.3 and R7.4 (where “R” signifies “Release”). The PBX component 320, moreover, may run three different releases of a certain software application: R6.0, R6.8 and R6.9. Finally the phone components 330 may run three different releases of a certain firmware application: R3.0, R3.2 and R3.5. There are as a result of these different software and firmware applications, 18 different possible combinations of software and firmware applications that the call center solution may run at any given time.

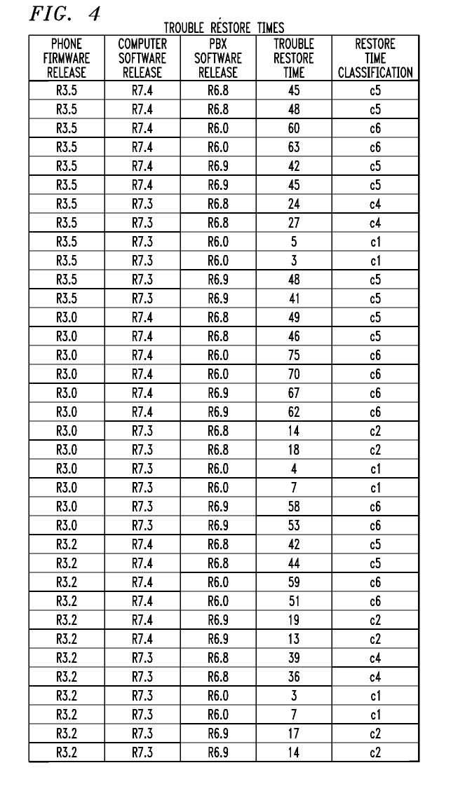

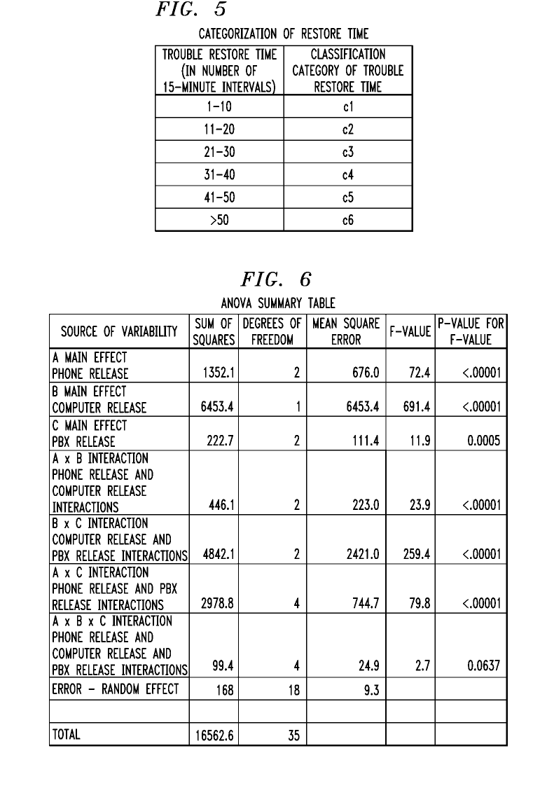

Applying step 220 to the exemplary call center solution 300 results in the table in FIG. 4. FIG. 4 shows trouble restore time as a function of the different combinations of the software/firmware applications running on the phone components 330, computer component 310 and PBX component 320. Two measurements of each possible combination of software/firmware applications are provided in the table, giving 36 separate entries. In addition to being shown in 15 minute increments, the trouble restore time is also classified into a restore time classification, labeled c1-c6. The meanings of the different classifications are shown in FIG. 5.

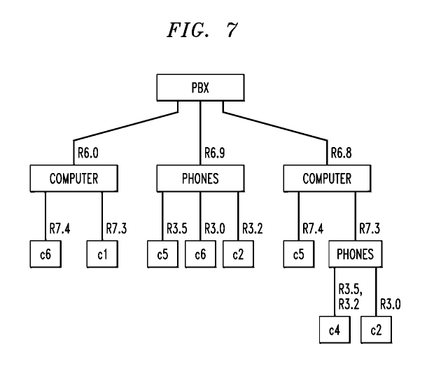

Application of step 230 to the exemplary call center solution 300 comprises applying well-known ANOVA techniques to the training data (i.e., the data populating the table in FIG. 4). FIG. 6 shows the ANOVA summary table for this training data. In accordance with conventional ANOVA techniques, the ANOVA analysis checks the following four types of effects:

1. Main Effects:
a. Effect of firmware releases of phone components 330
b. Effect of software releases of computer component 310
c. Effect of software releases of PBX component 320

2. Two-way Interactions:
a. Effect of interaction between firmware releases of phone components and software
releases of computer component
b. Effect of interaction between firmware releases of phone components and software releases of PBX component
c. Effect of interaction between software releases of computer component and software releases of PBX component

3. Three-way Interactions:
a. Effect of interaction of firmware releases of phone components and software releases of computer component and software releases of PBX component

4. Random Error due to random effects.

Consultation of the table in FIG. 6 yields at least three conclusions. First, each of the three main effects described above has a statistically significant impact on trouble restoration time with high confidence (i.e., >99% confidence as indicated by the corresponding P-values). Second, each of the three two-way interactions also has a statistically significant impact on trouble restore time, again with high confidence. Finally, the three-way interaction does not have a statistically significant impact on trouble restore time as shown by the relatively high P-value (i.e., can only declare significance with confidence of 93.6%).

Finally, applying step 240 to the exemplary call center solution 300 comprises applying a decision tree inference algorithm to the training data using as decision tree attributes the three system components determined in the last step to have a statistically significant effect on the trouble restore time metric. FIG. 7 shows the software interoperability decision tree obtained by applying a C5 decision tree inference algorithm. Through the various nodes, branches and endnodes of the resultant software interoperability decision tree, it can be readily observed that the combination of software applications for the call center solution predicted to result in the shortest trouble restore time classification (i.e., c1) comprises the PBX component 320 running software release R6.0, the computer component 310 running software release R7.3 and the phone components 330 running any one of firmware releases R3.0, R3.2 and R3.5. Moreover, the decision tree clearly shows how different combinations of software/firmware applications may result in less than optimal trouble restore times.

Consequently, applying a method in accordance with aspects of this invention yields a software interoperability model for a particular multi-application system (i.e., the call center solution 300) in the form of a software interoperability decision tree. Advantageously, such a decision tree allows a system administrator to optimize a particular system metric through targeted software/firmware changes or to identify software interoperability problems in multi-application systems exhibiting less than optimal system metrics. For example, in the case of the illustrative call center solution 300, the system administrator may decide to defer the upgrade of the computer component 310 to software release R7.4 because of the undesirable interoperability demonstrated with R6.0 of the PBX component 320, as identified in the software interoperability decision tree shown in FIG. 6.

It should be noted that aspects of the invention may further be useful in detecting software viruses and worms. Software viruses and worms may “infect” a multi-application system by making subtle, usually malicious, changes to one or more software applications within the system. Nevertheless, one skilled in the art will recognize that the infecting of a software application is largely analogous to changing the release of that software application. Accordingly, such changes may be detectable using methods and apparatus in accordance with aspects of the invention.

As described with reference to the modeling system I 10 in FIG. 1, aspects of the present invention may be implemented by an apparatus (e.g., the modeling system 110) comprising a data processor and a memory (e.g., a general purpose computer). As a result, an article of manufacture comprising a machine-readable storage medium for storing one or more programs (e.g., a magnetic disk, CD or DVD) that, when executed by a computer having a processor and a memory, are operative to cause the computer to perform method steps in accordance with aspects of this invention would also come within this invention.

It should also again be emphasized that the above-described embodiments of the invention are intended to be illustrative only. Other embodiments can use different system elements and method steps for implementing the described functionality. These numerous alternative embodiments within the scope of the following claims will be apparent to one skilled in the art.

What is claimed is:

1. A method of determining software interoperability in a system comprising a plurality of components capable of operating using a plurality of different combinations of software applications, the method comprising the steps of:
receiving training data for the system indicating changes to a system metric as a function of the plurality of different combinations of software applications;
determining from the training data which components within the plurality of components directly or through interactions with other components have a statistically significant effect on the system metric when changing between the plurality of different combinations of software applications; and
formulating from the training data a software interoperability decision tree for the system using those components determined to have a statistically significant effect on the system metric as decision tree attributes.

2. The method of claim 1, wherein the step of determining which components within the plurality of components directly or through interactions with other components have a statistically significant effect on the system metric comprises applying Analysis of Variance (ANOVA) techniques to the training data.

3. The method of claim 1, wherein the step of formulating the software interoperability decision tree comprises applying a decision tree inference algorithm to the training data.

4. The method of claim 3, wherein the decision tree inference algorithm comprises an Iterative Dichotomiser 3 (ID3) algorithm.

5. The method of claim 3, wherein the decision tree inference algorithm comprises at least one of C4, C4.5 and C5 algorithms.

6. The method of claim 1, wherein the system comprises a computer system.

7. The method of claim 1, wherein the system comprises an enterprise system.

8. The method of claim 1, wherein the system comprises a telecommunications network.

9. The method of claim 1, wherein the method is utilized for at least one of software virus detection and software worm detection.

10. An article of manufacture comprising a machine-readable storage medium for storing one or more programs for use in determining software interoperability in a system comprising a plurality of components capable of operating using a plurality of different combinations of software applications, the one or more programs, when executed by a computer having a processor and a memory, operative to cause the computer to perform the steps of claim 1.

11. An apparatus for determining software interoperability in a system comprising a plurality of components capable of operating using a plurality of different combinations of software applications, the apparatus including
a memory; and
a processor coupled to the memory, the processor operative to perform the steps of:
receiving training data for the system indicating changes to a system metric as a function of the plurality of different combinations of software applications;
determining from the training data which components within the plurality of components directly or through interactions with other components have a statistically significant effect on the system metric when changing between the plurality of different combinations of software applications; and
formulating from the training data a software interoperability decision tree for the system using those components determined to have a statistically significant effect on the system metric as decision tree attributes.

12. The apparatus of claim 11, wherein the step of determining which components within the plurality of components directly or through interactions with other components have a statistically significant effect on the system metric comprises applying Analysis of Variance (ANOVA) techniques to the training data.

13. The apparatus of claim 11, wherein the step of formulating the software interoperability decision tree comprises applying a decision tree inference algorithm to the training data.

14. The apparatus of claim 12, wherein the decision tree inference algorithm comprises an Iterative Dichotomiser 3 (ID3) algorithm.

15. The apparatus of claim 11, wherein the apparatus is connected to the system.

16. The apparatus of claim 11, wherein the apparatus is not connected to the system.

17. The apparatus of claim 11, wherein the apparatus comprises at least one of a personal computer and a mainframe computer.

18. A system including a multi-application system, the multi-application system comprising a plurality of components capable of operating using a plurality of different combinations of software applications, and a modeling apparatus, the modeling apparatus comprising a memory and a processor, the modeling apparatus operative to perform the steps of:
receiving training data for the system indicating changes to a system metric as a function of the plurality of different combinations of software applications;
determining from the training data which components within the plurality of components directly or through interactions with other components have a statistically significant effect on the system metric when changing between the plurality of different combinations of software applications; and
formulating from the training data a software interoperability decision tree for the system using those components determined to have a statistically significant effect on the system metric as decision tree attributes.

19. The system of claim 18, wherein the multi-application system and the modeling system are on the same computing platform.

20. The system of claim 18, wherein the multi-application system and the modeling system are on separate computing platforms.
